(19) United States
(12) Patent Application Publication
(10) Pub. No.: US 2003/0032900 A1
(43) Pub. Date: Feb. 13, 2003

(54) System and method for facial treatment

(75) Inventor: Sima Ella, Tel Aviv (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Engii (2001) Ltd.

(21) Appl. No.: 10/144,983

(22) Filed: May 15, 2002

Related U.S. Application Data
(60) Provisional application No. 60/310,479, filed on Aug. 8, 2001.
(60) Provisional application No. 60/349,984, filed on Jan. 23, 2002.

(51) Int. Cl. A61H 15/00; A61H 7/00

(52) U.S. Cl. 601/6; 601/15; 601/119; 601/123

(57) ABSTRACT

A system and method are provided for self-application of a variety of face and body treatments. Specifically, the system includes a portable control-and-power console and a light-weight portable device having a plurality of spouts, designed for different portions of the body, and comprising different features. The different features are adapted for different modes of therapy, such as suction massage therapy, warming light therapy, UV light therapy, LLLT, ultrasound therapy, pulsating magnetic field therapy, constant magnetic field therapy, electrostimulation therapy, cooling-diode therapy, and warming-diode therapy. Additionally, each spout includes at least two, and preferably three or more features, for applying different modes of therapy, in tandem or in sequence, in accordance with predetermined schedules.

### FIELD OF THE INVENTION

The present invention relates generally to devices for face and body treatments, and in particular, to devices, which employ suction massage therapy coupled with at least one additional mode of therapy.

### BACKGROUND OF THE INVENTION

Massage devices, which employ suction, are known. Generally, they include a structural casing, which defines a vacuum chamber with an open lower surface, and suction means. The casing is adapted for gliding along the portion of the body for treatment.

Utilizing a partial vacuum, they cause a lifting of the skin, to form a skin fold. As the device is moved across the body, the skin fold is rolled over by the casing. Thus the device imitates and automates a conventional massaging method, known as “palpate and roll”, which stimulates blood circulation.

Inner rollers may be arranged within the casing, so as to press against the skin folds. These may be associated with motorized drives, for a pinching-like effect, or may rotate freely with the movement of the device.

Massage devices, which employ suction, are described, for example, in U.S. Pat. No. 6,200,281, to Frajdenrajch, entitled, “Massaging device which is designed to be applied to the skin of a person,” U.S. Pat. No. 6,090,055, to Frajdenrajch, entitled, “Massaging Device,” U.S. Pat. No. 6,017,320 to Bleeker, et al., entitled, “Massaging apparatus having two rollers and a suction chamber,” U.S. Pat. No. 5,897,512 to Zagame, entitled, “Massage appliance for moving over a predetermined zone of the human body,” U.S. Pat. No. 3,841,323 to Dan, entitled “Massage Apparatus,” and U.S. Pat. No. 6,196,982, to Ball, entitled, “Vacuum massager,” whose disclosures are incorporated herein by reference.

U.S. Pat. No. 4,748,973, to Cho, entitled, “Pneumatic Massage Device,” whose disclosure is incorporated herein by reference, describes a pneumatic massage device, adapted for self-application, without the assistance of another person.

Both U.S. Pat. No. 3,906,940, to Kawada, entitled “Facial Treatment Device,” and U.S. Pat. No. 5,003,966, to Saka, et al., entitled, “Suction device,” whose disclosures are incorporated herein by reference, describe vacuum and massage devices that are adapted for facial treatment.

Another known form of face and body treatment is light therapy, and more specifically, low laser light therapy (LLLT). LLLT refers to laser light at an output of between 1 and 500 Mw. These values are not strong enough to damage chemical bonds in the tissue, but do cause a photochemical effect. LLLT is also referred to as “cold laser” or “soft laser.”

According to “The Healing Nature of light,” http://www.laserpath.com/lpwhatislllt.htm, 1998-2001 LaserPath Therapeutics, downloaded on Apr. 23, 2002, the physiological effects of LLLT include biostimulation, improved metabolism, increase cell metabolism, improved blood circulation and vasodilatation, an analgesic effect, anti-inflammatory and anti-edematous effects, and stimulation of wound healing.

Similarly, according to “Laser Therapy, http://www.skylarkdevice.com/english/laser_e.htm, 2000-2001 Skylark Inc., and according to LLLT, http://www.medsolution.de/LLLT.htm, both downloaded on Apr. 23, 2002, LLLT promotes the production of collagen and the synthesis of protein, accelerates blood circulation, increases lymphatic flow, excites cell division, improves immunity, revives white corpuscles, stimulates the synthesis of Adenosin Tri Phosphate (ATP), and increases the synthetic energy of nucleic acid. Additionally, LLLT can stimulate the skin to improve its tension and elasticity, reduce wrinkles, remove scars, and slow down skin aging.

LLLT penetrates the body to a depth of between 3-5 cm, depending on its wavelength. Light waves in the near infrared ranges penetrate the deepest of all light waves in the visible spectrum.

The recommended wavelength for biostimulation is in the range between 630 and 1200 nm.

U.S. Pat. No. 4,930,504 to Diamantopoulos, et al. entitled, “Device for biostimulation of tissue and method for treatment of tissue,” whose disclosure is incorporated herein by reference, describes a system and method for stimulation of skin and it underlying tissue by laser light of various wavelengths, preferably of at least three different wavelengths. The radiation sources are arranged within the array such that radiation of at least two different wavelengths passes directly or indirectly through a single point located within the treated tissue. The radiation sources are preferably laser diodes, superluminous diodes or similar light-emitting diodes that, while low-power radiation sources, can provide significant energy densities to a treatment area. A method of treatment of tissue comprising exposing the treated tissue to the above-described device is also disclosed. The device for biostimulation of tissue may be included within a system with a control panel, a power source, variable pulse frequency, variable pulse duration, a timer for timing the period of treatment, a device for measuring the conductivity of the treated tissue, a device for measuring the optical power emitted by the radiation sources and/or a device for detecting emissions from the radiation sources. When three different wavelengths are used, the first wavelength is selected from the group consisting of 650 nm, 660 nm, 680 nm, 750 nm, 780 nm, 800 nm, 810 nm and 820 nm; the second wavelength is selected from the group consisting of 830 nm, 840 nm, 850 nm, 860 nm, 870 nm, and 880 nm; and the third wavelength is selected from the group consisting of 900 nm, 904 nm, 950 nm, 1100 nm, 1300 nm and 1500 nm.

U.S. Pat. No. 5,445,146, to Bellinger, entitled, “Biological tissue stimulation by low level optical energy,” whose disclosure is incorporated herein by reference, describes a method of irradiating a biological tissue of a living subject with optical energy. The wavelength and power dissipation level are such as to cause the amount of optical energy absorbed and converted to heat in the tissue to be within a range bounded by a minimum absorption rate sufficient to elevate the average temperature of the irradiated tissue to a level above the basal body temperature, but which is less than the absorption rate at which tissue is converted into a collagenous substance. According to this method, a therapeutic, warming effect is produced within the irradiated tissue, but without causing tissue damage by thermal overheating. The method of using a low level reactive laser system from 100 milliwatts to 800 milliwatts in either a pulsed or continuous mode with optical energy produced by a Nd:YAG laser at a fundamental wavelength of 1064 nanometers has been found to reduce pain in soft tissues, reduce inflammation and enhance the healing of tissue by stimulation of microcirculation without subjecting the living tissue to damaging thermal effects. The energy density of the irradiated tissue is limited to the range of from about 1 joule per square centimeter to about 15 joules per square centimeter.

Light therapy at other wavelengths is also known. For example, U.S. Pat. No. 4,558,700, to Mutzhas, entitled, “UV Radiation device for phototherapy of dermatoses, especially psoriasis,” whose disclosure is incorporated herein by reference, describes a UV radiation device for phototherapy of dermatoses, especially psoriasis. The device produces UV radiation at a wavelength range below 300 nm at a first intensity, and radiation at a wavelength range between 300 and 310 nm, at a second intensity, substantially higher than the first intensity. The radiation dose being between 0.7 and 1.0 times the erythema threshold dose. Such a UV radiation device is distinguished by good therapeutic effectiveness and the avoidance of undesirable side effects. The power delivered to the skin using Mutzhas lamp is described as 150W/M², which does not have a significant effect on skin temperature.

Similarly, U.S. Pat. No. 4,354,139, to Konijnendijk, et al., entitled, “Low-pressure mercury vapor discharge lamp,” whose disclosure is incorporated herein by reference, describes a low-pressure mercury vapor discharge lamp for radiation purposes. The lamp has a discharge tube made of glass with selective transmission, the tube being coated on the inside with a luminescent layer. This layer contains a luminescent material, which has the characteristic line emission of gadolinium at 312 nm. The discharge tube is made of glass having an absorption edge located between 260 and 280 nm and the tube has at 312 nm a transmission of at least 80%. It is known that radiation in the wavelength range from 305-320 nm may have a favorable therapeutic effect, for example in the treatment of psoriasis and other skin diseases.

U.S. Pat. No. 5,755,751, to Eckhouse, entitled, “Method and apparatus for therapeutic electromagnetic treatment,” whose disclosure is incorporated herein by reference, describes a therapeutic treatment method includes the steps of providing a pulsed incoherent light output for treatment, directing the pulsed light output to a treatment area, transmitting the pulsed light output through the epidermis at the treatment area, heating the epidermis to a temperature below the temperature at which the epidermis is damaged, and coagulating blood in blood vessels disposed below the epidermis.

According to U.S. Pat. No. 5,755,751, hereinabove, when treating vascular disorder, blood content affects the absorption coefficient of the treatment area. Oxyhemoglobin is the main chromophore, which controls the optical properties of blood and has strong absorption bands in the visible region. More particularly, the strongest absorption peak of oxyhemoglobin occurs at 418 nm and has a band-width of 60 nm. Two additional absorption peaks with lower absorption coefficients occur at 542 and 577 nm. The total band-width of these two peaks is on the order of 100 nm. Additionally, light in the wavelength range of 500 to 600 nm is desirable for the treatment of blood vessel disorders of the skin since it is absorbed by the blood and penetrates through the skin. Longer wavelengths up to 1000 nm are also effective since they can penetrate deeper into the skin, heat the surrounding tissue and, if the pulse-width is long enough, contribute to heating the blood vessel by thermal conductivity. Also, longer wavelengths are effective for treatment of larger diameter vessels because the lower absorption coefficient is compensated for by the longer path of light in the vessel.

Accordingly, a wide band electromagnetic radiation source that covers the near UV and the visible portion of the spectrum would be desirable for treatment of external skin and vascular disorders. The overall range of wavelengths of the light source should be sufficient to optimize treatment for any of a number of applications. Such a therapeutic electromagnetic radiation device should also be capable of providing an optimal wavelength range within the overall range for the specific disorder being treated. The intensity of the light should be sufficient to cause the required thermal effect by raising the temperature of the treatment area to the required temperature. When using pulsed light, the pulse-width should be variable over a wide enough range so as to achieve the optimal penetration depth for each application. Therefore, it is desirable to provide a light source having a wide range of wavelengths, which can be selected according to the required skin treatment, with a controlled power output and pulse-width for a particular skin application.

Another known form of face and body treatment is ultrasound therapy. According to “Ultrasound Therapy,” Skylark Inc., http://www.skylarkdevice.com/english/ultrasonic_e.htm#head, ultrasound refers to acoustic waves over 20000 Hz, and in general, ultrasound devices for medical and beauty treatment range in frequency from 1 to 5 MHz. A safe standard for a continuous waveform ultrasound is about 1 W/cm², for about 15 minutes, for general muscle treatment. For facial treatment, it is about 0.5 W/cm², for about 10 minutes. A safe standard for a pulse waveform is about 240 mW/cm². By comparison, shattering kidney stones requires about 10 W/cm². The transmission of ultrasound in air is very low, and generally, an interface of a special gel needs to be used between the ultrasound transducer and the skin.

Ultrasound causes a massaging or vibrating action, which may be regarded as a micro-massaging action. A consequence of it is a heating action. Massaging with 1 MHz for ten minutes may cause a temperature increase of 0.5-1° C., at a tissue depth of 4-5 cm. The warming effect increases blood circulation and tissue metabolism. Ultrasound also causes cavitation of the interface material, which leads to a cleansing of the skin. Additionally, ultrasound increases skin absorption of external matter.

Skylark Incorporated (12th FL., 34, Sec. 3, Chuang Shan N. Rd., Taipei, 104, Taiwan Tel: 886-2-25979005 Fax: 886-2-25912344), carries several products for ultrasound treatment. For example, Ultrasound Therapy Unit (1 MHz) SD957 is a lightweight device that operates at 1 MHz. It is used for treating deep textures, 2-4 cm into the skin, for example, in regions of the leg, the hip, the back, and the like. Ultrasound Beauty SD-958, a beauty/skin care device, operating at 3 MHz, is specifically adapted for facial treatment.

U.S. Pat. No. 6,325,769, to Klopotek, entitled, “Method and apparatus for therapeutic treatment of skin,” whose disclosure is incorporated herein by reference, describes a method and apparatus which use ultrasound for a therapeutic treatment. According to Klopotek, controlled application of ultrasound energy into the dermis layer reduces the extent of wrinkles and rejuvenate the skin. The ultrasound energy triggers a biological response that causes synthesis of new connective tissue in the dermis through activation of fibroblast cells in the dermis without causing or requiring a significant irritation or damage to the epidermis. One purpose of the present method is to provide a cosmetic improvement in the appearance of the skin, meaning that the treated skin surface will have a smoother, rejuvenated appearance, without the need to induce a significant damage to the epidermis layer of the skin.

U.S. Pat. No. 5,665,053 to Jacobs, entitled “Apparatus for performing endermology with ultrasound,” whose disclosure is incorporated herein by reference, describes an endermology body massager having at least two rollers spaced from each other in a parallel configuration. The rollers rotate in the same direction and are mounted on movable axes. A vacuum source is connected to the chamber that houses the rollers. The vacuum source facilitates the suction of the skin between the rollers and, helps bring the rollers closer to each other during operation. The rollers or housing have ultrasound generators that are selectively controlled by the operator. In a first embodiment, the ultrasound generators are located within the rollers. In the second embodiment, the ultrasound generators are disposed in the housing around the rollers. Therefore, a controlled and combined endermology with ultrasound treatment can be achieved.

Another known form of face and body treatment is magnetic therapy. According to “Magnetic and Electromagnetic Therapy,” By David Ramey, www.hcrc.organism/conntriib/ramey/magnet/html, Health Care Reality Check, downloaded on Nov. 20, 2001, researchers believe that a pulsating magnetic field may stimulate biological processes, pertinent for example, to osteogenesis, healing of chronic wounds, and neuroonal regeneration.

U.S. Pat. No. 5,669,868, to Markoll, “Treatment of wrinkled discolored or aging skin with magnetic field therapy,” whose disclosure is incorporated herein by reference, describes a process for treating skin by subjecting it to magnetic therapy by an annular coil energized by pulsed D.C. voltage having a rectangular wave form pulsing at the rate of 1-30 CPS, the coil producing a field of under 20 gauss.

Each of the aforementioned treatment system has specific advantages. A person wishing to benefit from these would have to attend a treatment clinic offering a wide choice of treatment devices, or acquire many different devices, suffering the associated expense and space requirements.

There is thus a need for a device for self-applied face and body treatment, devoid of the above limitations.

### SUMMARY OF THE INVENTION

According to an aspect of the present invention, there is provided a device for face and body treatment, comprising:

a spout, having a casing which defines an inner chamber, the spout being adapted for gliding along a portion of a body and applying suction massage therapy is thereto;

a gripping handle, to which the spout is attached;

a vacuum hose, in fluid communication with the spout;

at least one light source, arranged within the inner chamber, adapted for applying light therapy, to the portion of the body; and

a power line, in power communication with the at least one light source.

According to an additional aspect of the present invention, the gripping handle defines a lumen therein and comprises the vacuum hose.

According to an additional aspect of the present invention, the power line is imbedded within the casing.

According to an additional aspect of the present invention, the gripping handle comprises a connector, adapted to selectably receive and selectably detach the spout.

According to an additional aspect of the present invention, the connector is adapted for swivel motion.

According to an additional aspect of the present invention, the spout includes at least one roller.

According to an additional aspect of the present invention, the spout includes at least two rollers.

According to an additional aspect of the present invention, the spout is adapted to selectably apply each of the suction massage therapy and light therapy individually, and in tandem.

According to an additional aspect of the present invention, the light therapy is selected from the group consisting of warming light therapy, UV light therapy, LLLT, and a combination thereof.

According to an additional aspect of the present invention, the at least one light source comprises a plurality of light sources of a same type.

According to an additional aspect of the present invention, the at least one light source comprises a plurality of light sources of different types.

According to an additional aspect of the present invention, the at least one light source is adapted for heating the portion of the body.

According to an additional aspect of the present invention, the at least one light source comprises a mercury vapor discharge lamp.

According to an additional aspect of the present invention, the at least one light source comprises at least one laser light.

According to an additional aspect of the present invention, the at least laser light comprises at least two laser lights of a same wavelength.

According to an additional aspect of the present invention, the at least one laser light comprises at least two laser lights of different wavelengths.

According to an additional aspect of the present invention, the at least one laser light is a pulsating laser light.

According to an additional aspect of the present invention, the at least one laser light comprises at least one laser light diode.

According to an additional aspect of the present invention, the at least one light source is operative at a wavelength range of 250-400 nm.

According to an additional aspect of the present invention, the at least one light source is operative at a wavelength range of 300-320 nm.

According to an additional aspect of the present invention, the at least one light source is operative at a wavelength range of 400-600 nm.

According to an additional aspect of the present invention, the at least one light source is operative at a wavelength range of 600-700 nm.

According to an additional aspect of the present invention, the at least one light source is operative at a wavelength range of 700-900 nm.

According to an additional aspect of the present invention, the at least one light source is operative at a wavelength range of 900-1100 nm.

According to an additional aspect of the present invention, the at least one light source is operative at a wavelength range of 1100-1500 nm.

According to an additional aspect of the present invention, the spout includes a first additional feature, for applying a first additional mode of therapy, selected from the group consisting of ultrasound therapy, pulsating magnetic field therapy, constant magnetic field therapy, electrostimulation therapy, cooling-diode therapy, and warming-diode therapy, wherein the therapies may be selectably applied in tandem and selectably applied in sequence, in accordance with predetermined restrictions.

According to an additional aspect of the present invention, the therapies may be applied in accordance with a predetermined schedule.

According to an additional aspect of the present invention, the spout includes a second additional feature, for applying a second additional mode of therapy, different from the first additional mode, the second additional mode of therapy being selected from the group consisting of ultrasound therapy, pulsating magnetic field therapy, constant magnetic field therapy, electrostimulation therapy, cooling-diode therapy, and warming-diode therapy, wherein the therapies may be selectably applied in tandem and selectably applied in sequence, in accordance with predetermined restrictions.

According to an additional aspect of the present invention, the therapies may be applied in accordance with a predetermined schedule.

According to an additional aspect of the present invention, the device includes at least one control knob.

According to an additional aspect of the present invention, the device is adapted for self-application.

According to another aspect of the present invention, there is also provided a device for face and body treatment, comprising:

a spout, having a casing which defines an inner chamber, the spout being adapted for gliding along a portion of a body and applying suction massage therapy thereto;

a gripping handle, to which the spout is attached;

a vacuum hose, in fluid communication with the spout;

an electromagnet, for applying a magnetic field therapy, to the portion of the body; and

a power line, in power communication with the electromagnet.

According to an additional aspect of the present invention, the gripping handle defines a lumen therein and comprises the vacuum hose.

According to an additional aspect of the present invention, the power line is imbedded within the casing.

According to an additional aspect of the present invention, the gripping handle comprises a connector, adapted to selectably receive and selectably detach the spout.

According to an additional aspect of the present invention, the connector is adapted for swivel motion.

According to an additional aspect of the present invention, the spout includes at least one roller.

According to an additional aspect of the present invention, the spout includes at least two rollers.

According to an additional aspect of the present invention, the magnetic field therapy is selected from the group consisting of pulsating magnetic field therapy and constant magnetic field therapy.

According to an additional aspect of the present invention, the spout is adapted to selectably apply each of the suction massage therapy and magnetic field therapy individually, and in tandem.

According to an additional aspect of the present invention, the spout includes a first additional feature, for applying a first additional mode of therapy, selected from the group consisting of warming light therapy, UV light therapy, LLLT, ultrasound therapy, electrostimulation therapy, cooling-diode therapy, and warming-diode therapy, wherein the therapies may be selectably applied in tandem and selectably applied in sequence, in accordance with predetermined restrictions.

According to an additional aspect of the present invention, the therapies may be applied in accordance with a predetermined schedule.

According to an additional aspect of the present invention, the spout includes a second additional feature, for applying a second additional mode of therapy, different from the first additional mode, the second additional mode of therapy being selected from the group consisting of warming light therapy, UV light therapy, LLLT, ultrasound therapy, electrostimulation therapy, cooling-diode therapy, and warming-diode therapy, wherein the therapies may be selectably applied in tandem and selectably applied in sequence, in accordance with predetermined restrictions.

According to an additional aspect of the present invention, the therapies may be applied in accordance with a predetermined schedule.

According to an additional aspect of the present invention, the device includes at least one control knob.

According to an additional aspect of the present invention, the device is adapted for self-application.

According to another aspect of the present invention, there is also provided a device for face and body treatment, comprising:

a spout, having a casing which defines an inner chamber, the spout being adapted for gliding along a portion of a body and applying suction massage therapy thereto;

a gripping handle, to which the spout is attached;

a vacuum hose, in fluid communication with the spout;

an electrode pair, for applying a electrostimulation therapy, to the portion of the body; and

a power line, in power communication with the electrode pair.

According to an additional aspect of the present invention, the gripping handle defines a lumen therein and comprises the vacuum hose.

According to an additional aspect of the present invention, the power line is imbedded within the casing.

According to an additional aspect of the present invention, the gripping handle comprises a connector, adapted to selectably receive and selectably detach the spout.

According to an additional aspect of the present invention, the connector is adapted for swivel motion.

According to an additional aspect of the present invention, the spout includes at least one roller.

According to an additional aspect of the present invention, the spout includes at least two rollers.

According to an additional aspect of the present invention, the spout includes a first additional feature, for applying a first additional mode of therapy, selected from the group consisting of warming light therapy, UV light therapy, LLLT, pulsating magnetic field therapy, constant magnetic field therapy, ultrasound therapy, cooling-diode therapy, and warming-diode therapy, wherein the therapies may be selectably applied in tandem and selectably applied in sequence, in accordance with predetermined restrictions.

According to an additional aspect of the present invention, the therapies may be applied in accordance with a predetermined schedule.

According to an additional aspect of the present invention, the spout includes a second additional feature, for applying a second additional mode of therapy, different from the first additional mode, the second additional mode of therapy being selected from the group consisting of warming light therapy, UV light therapy, LLLT, pulsating magnetic field therapy, constant magnetic field therapy, ultrasound therapy, cooling-diode therapy, and warming-diode therapy, wherein the therapies may be selectably applied in tandem and selectably applied in sequence, in accordance with predetermined restrictions.

According to an additional aspect of the present invention, the therapies may be applied in accordance with a predetermined schedule.

According to an additional aspect of the present invention, the device includes at least one control knob.

According to an additional aspect of the present invention, the device is adapted for self-application.

According to another aspect of the present invention, there is also provided a device for face and body treatment, comprising:

a spout, having a casing which defines an inner chamber, the spout being adapted for gliding along a portion of a body and applying suction massage therapy thereto;

a gripping handle, to which the spout is attached;

a vacuum hose, in fluid communication with the spout;

at least one cooling diode;

a power line, in power communication with the at least one cooling diode.

According to an additional aspect of the present invention, the gripping handle defines a lumen therein and comprises the vacuum hose.

According to an additional aspect of the present invention, the power line is imbedded within the casing.

According to an additional aspect of the present invention, the gripping handle comprises a connector, adapted to selectably receive and selectably detach the spout.

According to an additional aspect of the present invention, the connector is adapted for swivel motion.

According to an additional aspect of the present invention, the spout includes at least one roller.

According to an additional aspect of the present invention, the spout is adapted to selectably apply cooling-diode therapy and the suction massage therapy individually, and in tandem.

According to an additional aspect of the present invention, the at least one cooling diode includes at least two cooling diodes.

According to an additional aspect of the present invention, the at least one cooling diode may be flipped so as to operate as a warming diode, for providing warming-diode therapy.

According to an additional aspect of the present invention, the device includes at least one warming diode, wherein the cooling diode and the warming diode operate in cycles for cooling—warming therapy.

According to an additional aspect of the present invention, the spout includes a first additional feature, for applying a first additional mode of therapy, selected from the group consisting of warming light therapy, UV light therapy, LLLT, pulsating magnetic field therapy, constant magnetic field therapy, ultrasound therapy, and electrostimulation therapy, wherein the therapies may be selectably applied in tandem and selectably applied in sequence, in accordance with predetermined restrictions.

According to an additional aspect of the present invention, the therapies may be applied in accordance with a predetermined schedule.

According to an additional aspect of the present invention, the spout includes a second additional feature, for applying a second additional mode of therapy, different from the first additional mode, the second additional mode of therapy being selected from the group consisting of warming light therapy, UV light therapy, LLLT, pulsating magnetic field therapy, constant magnetic field therapy, ultrasound therapy, and electrostimulation therapy, wherein the therapies may be selectably applied in tandem and selectably applied in sequence, in accordance with predetermined restrictions.

According to an additional aspect of the present invention, the therapies may be applied in accordance with a predetermined schedule.

According to an additional aspect of the present invention, the device includes at least one control knob.

According to an additional aspect of the present invention, the device is adapted for self-application.

According to another aspect of the present invention, there is also provided a system for face and body treatment, comprising:

a device for face and body treatment; and

a power-and-control console, comprising:

an electric pump, in fluid communication with the device, for providing suction;

a power supply, in power communication with the device and the electric pump; and

at least one console control knob.

According to another aspect of the present invention, there is also provided a system for face and body treatment, comprising:

A device for face and body treatment, comprising:

a spout, having a casing which defines an inner chamber, the spout being adapted for gliding along a portion of a body and applying thereto a basic mode of therapy in a form of suction massage therapy, and the spout comprising a feature, adapted for applying an added mode of therapy, selected from the group consisting of warming light therapy, UV light therapy, LLLT, pulsating magnetic field therapy, constant magnetic field therapy, electrostimulation therapy, cooling-diode therapy, and warming-diode therapy;

a gripping handle, to which the spout is attached;

a vacuum hose, in fluid communication with the spout; and

a power line, in power communication with the feature; and

a power-and-control console, comprising:

an electric pump, in fluid communication with the vacuum hose, for providing suction;

a power supply, in power communication with the power line and the electric pump; and

at least one console control knob.

According to an additional aspect of the present invention, the gripping handle defines a lumen therein and comprises the vacuum hose.

According to an additional aspect of the present invention, the power line is imbedded within the casing.

According to an additional aspect of the present invention, the gripping handle comprises a connector, adapted to selectably receive and selectably detach the spout.

According to an additional aspect of the present invention, the connector is adapted for swivel motion.

According to an additional aspect of the present invention, the system includes at least one additional spout, designed to be received by the connector and adapted to apply a basic mode of therapy, selected from the group consisting of suction massage therapy, warming light therapy, UV light therapy, LLLT, pulsating magnetic field therapy, constant magnetic field therapy, ultrasound therapy, electrostimulation therapy, cooling-diode therapy, and warming-diode therapy.

According to an additional aspect of the present invention, the system includes at least one additional spout, designed to be received by the connector and adapted to apply a basic mode of therapy and an added mode of therapy, different from the basic mode, both modes of therapy being selected from the group consisting of suction massage therapy, warming light therapy, UV light therapy, LLLT, pulsating magnetic field therapy, constant magnetic field therapy, electrostimulation therapy, cooling-diode therapy, and warming-diode therapy.

According to an additional aspect of the present invention, the spout includes at least one roller.

According to an additional aspect of the present invention, the spout includes at least two rollers.

According to an additional aspect of the present invention, the spout is adapted to selectably apply each of the suction massage therapy and the added mode of therapy individually, and in tandem.

According to an additional aspect of the present invention, the spout is adapted to apply each of the suction massage therapy and the added mode of therapy in accordance with a predetermined schedule.

According to an additional aspect of the present invention, the spout includes a first additional feature, for applying a first additional mode of therapy, selected from the group consisting of warming light therapy, UV light therapy, LLLT, pulsating magnetic field therapy, constant magnetic field therapy, ultrasound therapy, electrostimulation therapy, cooling-diode therapy, and warming-diode therapy, wherein the therapies may be selectably applied in tandem and selectably applied in sequence, in accordance with predetermined restrictions.

According to an additional aspect of the present invention, the therapies may be applied in accordance with a predetermined schedule.

According to an additional aspect of the present invention, the spout includes a second additional feature, for applying a second additional mode of therapy, different from the first additional mode, the second additional mode of therapy being selected from the group consisting of warming light therapy, UV light therapy, LLLT, pulsating magnetic field therapy, constant magnetic field therapy, ultrasound therapy, electrostimulation therapy, cooling-diode therapy, and warming-diode therapy, wherein the therapies may be selectably applied in tandem and selectably applied in sequence, in accordance with predetermined restrictions.

According to an additional aspect of the present invention, the therapies may be applied in accordance with a predetermined schedule.

According to an additional aspect of the present invention, the device includes at least one device control knob.

According to an additional aspect of the present invention, the system is portable.

According to an additional aspect of the present invention, the power supply includes a battery.

According to an additional aspect of the present invention, the system includes a controller.

According to an additional aspect of the present invention, the system includes a display panel.

According to an additional aspect of the present invention, the display panel is interactive.

According to an additional aspect of the present invention, the device is adapted for self-application.

According to another aspect of the present invention, there is also provided a method for face and body treatment, comprising:

employing a single device;

applying a basic mode of therapy, selected from the group consisting of suction massage therapy, warming light therapy, UV light therapy, LLLT, pulsating magnetic field therapy, constant magnetic field therapy, electrostimulation therapy, cooling-diode therapy, and warming-diode therapy; and

applying an added mode of therapy, different from the basic mode, the added mode of therapy being selected from the group consisting of suction massage therapy, warming light therapy, UV light therapy, LLLT, pulsating magnetic field therapy, constant magnetic field therapy, electrostimulation therapy, cooling-diode therapy, and warming-diode therapy,

wherein the basic and added modes of therapy may be selectably applied in tandem, and selectably applied in sequence, in accordance with predetermined restrictions.

According to an additional aspect of the present invention, the basic and added modes of therapy are applied in accordance with a predetermined schedule.

According to an additional aspect of the present invention, the basic and added modes of therapy are self-applied.

According to an additional aspect of the present invention, the method includes applying a first additional mode of therapy, different from the basic and added modes, the first additional mode of therapy being selected from the group consisting of suction massage therapy, warming light therapy, UV light therapy, LLLT, ultrasound therapy, pulsating magnetic field therapy, constant magnetic field therapy, electrostimulation therapy, cooling-diode therapy, and warming-diode therapy,

wherein the therapies may be selectably applied in tandem, and selectably applied in sequence, in accordance with predetermined restrictions.

According to an additional aspect of the present invention, the therapies are applied in accordance with a predetermined schedule.

According to an additional aspect of the present invention, the therapies are self-applied.

According to an additional aspect of the present invention, the, method includes applying a second additional mode of therapy, different from the first additional mode and the basic and added modes, the second additional mode of therapy being selected from the group consisting of suction massage therapy, warming light therapy, UV light therapy, LLLT, ultrasound therapy, pulsating magnetic field therapy, constant magnetic field therapy, electrostimulation therapy, cooling-diode therapy, and warming-diode therapy,

wherein therapies may be selectably applied in tandem, and selectably applied in sequence, in accordance with predetermined restrictions.

According to an additional aspect of the present invention, the therapies are applied in accordance with a predetermined schedule.

According to an additional aspect of the present invention, the therapies are self-applied.

According to another aspect of the present invention, there is also provided a system for face and body treatment, comprising:

a device for face and body treatment, comprising:

a spout, comprising a first feature, adapted for applying a basic mode of therapy, and a second feature, adapted for applying an added mode of therapy, different from the first mode, both modes of therapy being selected from the group consisting of warming light therapy, UV light therapy, LLLT, ultrasound therapy, pulsating magnetic field therapy, constant magnetic field therapy, electrostimulation therapy, cooling-diode therapy, and warming-diode therapy;

a gripping handle, to which the spout is attached; and

a power line, in power communication with the first and second features; and

a power-and-control console, comprising:

a power supply, in power communication with the device; and

at least one console control knob.

According to an additional aspect of the present invention, the power line is imbedded within the gripping handle.

According to an additional aspect of the present invention, the gripping handle comprises a connector, adapted to selectably receive and selectably detach the spout.

According to an additional aspect of the present invention, the connector is adapted for swivel motion.

According to an additional aspect of the present invention, the system includes at least one additional spout, designed to be received by the connector and adapted to apply a basic mode of therapy, selected from the group consisting of warming light therapy, UV light therapy, LLLT, pulsating magnetic field therapy, constant magnetic field therapy, ultrasound therapy, electrostimulation therapy, cooling-diode therapy, and warming-diode therapy.

According to an additional aspect of the present invention, the system includes at least one additional spout, designed to be received by the connector and adapted to apply a basic mode of therapy and an added mode of therapy, different from the basic mode, both modes of therapy being selected from the group consisting of warming light therapy, UV light therapy, LLLT, ultrasound therapy, pulsating magnetic field therapy, constant magnetic field therapy, electrostimulation therapy, cooling-diode therapy, and warming-diode therapy.

According to an additional aspect of the present invention, the spout includes a first additional feature, for applying a first additional mode of therapy, selected from the group consisting of warming light therapy, UV light therapy, LLLT, pulsating magnetic field therapy, constant magnetic field therapy, ultrasound therapy, electrostimulation therapy, cooling-diode therapy, and warming-diode therapy, wherein the therapies may be selectably applied in tandem and selectably applied in sequence, in accordance with predetermined restrictions.

According to an additional aspect of the present invention, the therapies may be applied in accordance with a predetermined schedule.

According to an additional aspect of the present invention, the spout includes a second additional feature, for applying a second additional mode of therapy, different from the first additional mode, the second additional mode of therapy being selected from the group consisting of warming light therapy, UV light therapy, LLLT, pulsating magnetic field therapy, constant magnetic field therapy, ultrasound therapy, electrostimulation therapy, cooling-diode therapy, and warming-diode therapy, wherein the therapies may be selectably applied in tandem and selectably applied in sequence, in accordance with predetermined restrictions.

According to an additional aspect of the present invention the therapies may be applied in accordance with a predetermined schedule.

According to an additional aspect of the present invention, the device includes at least one device control knob.

According to an additional aspect of the present invention, the system is portable.

According to an additional aspect of the present invention, the power supply includes a battery.

According to an additional aspect of the present invention, the battery is rechargeable.

According to an additional aspect of the present invention, the system includes a controller.

According to an additional aspect of the present invention, the system includes a display panel.

According to an additional aspect of the present invention, the display panel is interactive.

According to an additional aspect of the present invention, the therapies may be selectably applied in tandem and selectably applied in sequence, in accordance with predetermined restrictions.

According to an additional aspect of the present invention, wherein the therapies may be applied in accordance with a predetermined schedule.

According to an additional aspect of the present invention, the device is adapted for self-application.

The present invention successfully addresses the shortcomings of the presently known configurations by providing a system and method for self-application of a variety of face and body treatments. Specifically, the system includes a portable control-and-power console and a lightweight device having a plurality of spouts, designed for different portions of the body, and comprising different features. The different features are adapted for different modes of therapy, such as suction massage therapy, warming light therapy, UV light therapy, LLLT, ultrasound therapy, pulsating magnetic field therapy, constant magnetic field therapy, electrostimulation therapy, cooling-diode therapy, and warming-diode therapy. Additionally, each spout includes at least two, and preferably three or more features, for applying different modes of therapy, in tandem or in sequence, in accordance with predetermined schedules.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A-1G schematically illustrate a device for face and body treatment, in accordance with a preferred embodiment of the present invention;

FIGS. 2A-2B schematically illustrate a spout for applying suction to the skin, in accordance with preferred embodiments of the present invention;

FIGS. 3A-3B schematically illustrate a spout, comprising at least one light source, for providing light therapy, in accordance with preferred embodiments of the present invention;

FIGS. 4A-4B schematically illustrate a spout, comprising an ultrasound transducer, in accordance with a preferred embodiment of the present invention;

FIGS. 5A-5B schematically illustrate a spout, comprising an electromagnet, in accordance with preferred embodiments of the present invention;

FIGS. 6A-6C schematically illustrate a spout, comprising electrostimulating electrodes, for providing electrostimulation therapy, in accordance with a preferred embodiment of the present invention;

FIG. 7 schematically illustrates a spout, comprising cooling diodes, for providing cooling-diode therapy, in accordance with a preferred embodiment of the present invention;

FIG. 8 schematically illustrates a spout, comprising laser diodes and cooling diodes, in accordance with a preferred embodiment of the present invention;

FIGS. 9A-9B schematically illustrate a power-and-control console in accordance with preferred embodiments of the present invention;

FIG. 10 schematically illustrates a system for face and body treatment, in accordance with a preferred embodiment of the present invention; and

FIG. 11 delineates restrictions regarding the different modes of therapy, in accordance with the present invention.

### DESCRIPTION OF THE PREFERRED EMBODIMENTS

The present invention is of a system and method for self-application of a variety of face and body treatments. Specifically, the system includes a portable control-and-power console and a lightweight device having a plurality of spouts, designed for different portions of the body, and comprising different features. The different features are adapted for different modes of therapy, such as suction massage therapy, warming light therapy, UV light therapy, LLLT, ultrasound therapy, pulsating magnetic field therapy, constant magnetic field therapy, electrostimulation therapy, cooling-diode therapy, and warming-diode therapy. Additionally, each spout includes at least two, and preferably three or more features, for applying different modes of therapy, in tandem or in sequence, in accordance with predetermined schedules.

The principles and operation of a the device and method according to the present invention may be better understood with reference to the drawings and accompanying descriptions.

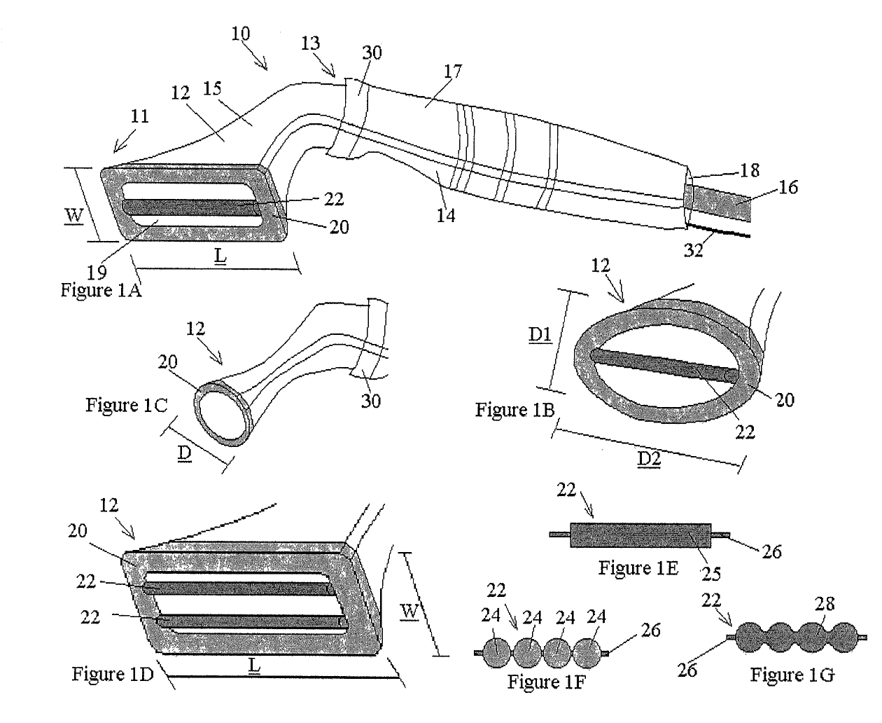

Referring now to the drawings, FIGS. 1A-1G schematically illustrate a device 10 for face and body treatment, in accordance with a preferred embodiment of the present invention. Device 10 is a massage device, which employs suction, imitating the conventional massaging method, “palpate and roll”, and stimulating blood circulation.

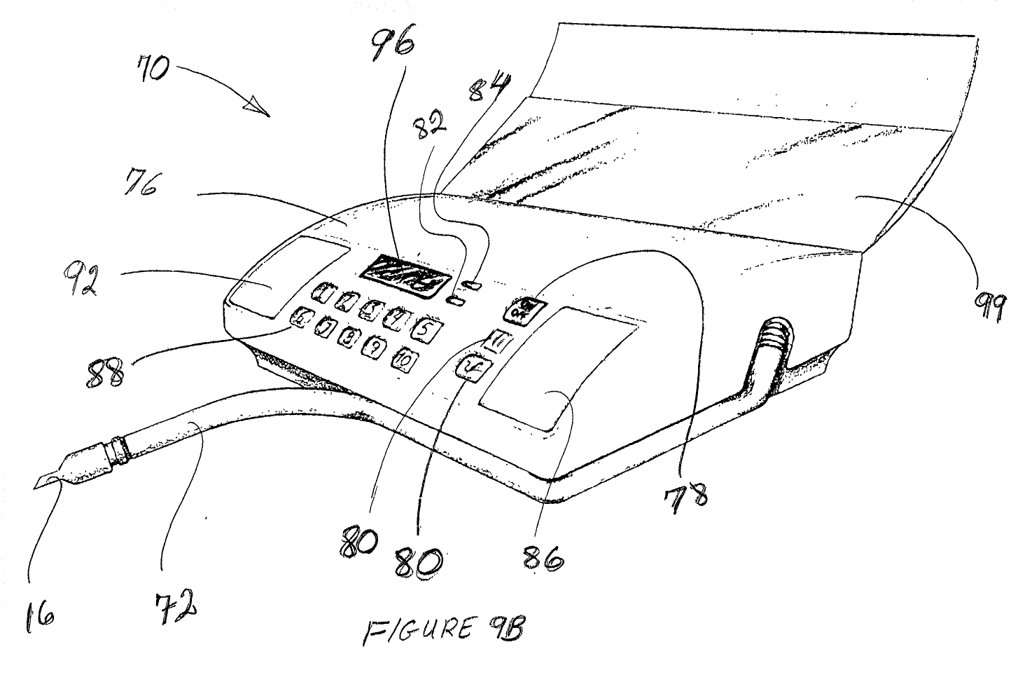

Device 10 includes a spout 12, adapted for gliding along a portion of a body and applying suction thereto. Spout 12 has proximal and distal ends, 11 and 13, with respect to the body, and a casing 15, which defines an inner chamber 19 therein. Spout 12 is attached to a gripping handle 14, at distal end 13. Gripping handle 14 has a casing 17, which defines a lumen 18, wherein a vacuum hose 16 is arranged, for providing suction to spout 12. Additionally, a power cable 32, described hereinbelow in conjunction with FIGS. 9A and 9B, is embedded within casing 15, or within lumen 18. Gripping handle 14 is preferably ergonomically designed, preferably for self-use.

Preferably, device 10 is aesthetically designed and colored. A choice of colors may be provided. Casing 15 of spout 12 and casing 17 of gripping handle 14 may be formed of a rigid plastic, for example, PVC, a combination of wood and plastic, a combination of natural or synthetic rubber and plastic, or the like.

At proximal end 1, spout 12 has a surface 20, which makes contact with the portion of the body under treatment, as device 10 glides along it. Surface 20 may be elliptical, circular, rectangular or of another shape, and is preferably formed as a replaceable pad, preferably of silicon, or another material that is preferably biocompatible, nonallergenic, and soft to the touch. During use, a lubricant, such as a facial cream or a gel may be used between surface 20 and skin 40.

In accordance with a preferred embodiment of the present invention, a plurality lo of spouts 12 may be provided, of different sizes and shapes, each adapted for a particular portion of the body. For example, for applying suction generally to the face, rectangular spout 12 of FIG. 1A, having a length L substantially of 25 mm, and a width W substantially of 10 mm, with an inner roller of substantially 3 mm in diameter, may be used. Alternatively, an elliptical spout 12 of FIG. 1B, having a minor diameter D1 substantially of 10 mm, and a major diameter D2 substantially of 25 mm, may be used. Alternatively, a 30-mm circular cross section may be used. Yet, for the area under the eyes, circular spout 12, of FIG. 1C, having a diameter of between 4 and 15 mm may be preferred. For applying suction to other portions of the body, for example, the thighs, rectangular spout 12 of FIG. 1D, which is much larger than that of FIG. 1A, substantially of 75 mm in length, and 35 mm in width, may be chosen. It will be appreciated that these choices are individual, and different users may select differently. It will be further appreciated that other dimensions may similarly be used.

Spout 12 may be affixed onto gripping handle 14 in a manner similar to that by which different attachments are affixed onto a vacuum cleaner. For example, gripping handle 14 may include a connector 30, operative as a socket, for receiving distal end 13 of spout 12. Preferably connector 30 has a swivel motion, for example of 90 or 120 degrees.

Additionally, device 10 may include at least one roller 22, arranged at proximal end 11, and protruding proximally from surface 20, for increasing the massaging action to the portion of the body under treatment. As shown in FIG. 1E, roller 22 may be a cylinder 25, arranged on a shaft 26. Alternatively, as shown in FIG. 1F, roller 22 may include balls 24 arranged on shaft 26. Alternatively, as shown in FIG. 1G, roller 22 may have a wavy structure 28, arranged on shaft 26. Alternatively, another roller may be used. Roller 22 may be formed, for example, of rigid plastic, PVC, wood, natural or synthetic rubber, or another suitable material. Alternatively, a bar 22, which does not rotate with the motion of spout 12, may be used.

Preferably, roller 22 may be selectably inserted into spout 12 when a massaging action is desired, and selectably removed from spout 12, for suction without massage. Additionally, spout 12 may be provided with several rollers 22, for example, from amongst those seen in FIGS. 1E-1G, and a user (not shown) may select roller 22 of a desired shape. Furthermore, spout 12 may be adapted to include two or more rollers, as seen in FIG. 1D. Preferably, roller 22 is manually powered, arranged to roll as spout 12 glides along the portion of the body under treatment. Alternatively, roller 22 may be electrically powered.

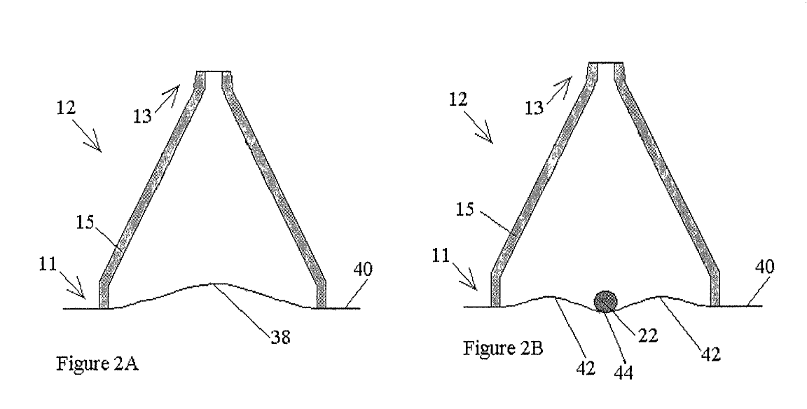

Referring further to the drawings, FIGS. 2A-2B schematically illustrate spout 12, applying suction to skin 40, in accordance with preferred embodiments of the present invention. As seen in FIG. 2A, when suction is applied to skin 40, a skin hump 38 is formed within spout 12. As device 10 is moved across the body, skin hump 38 is rolled over by casing 15, to produce the massaging action.

As seen in FIG. 2B, when suction is applied, while roller 22 presses down on skin 40, two skin humps 42 are formed, separated by a skin depression 44, that is created by roller 22. Thus both casing 15 and roller 22 participate in the massaging action.

In accordance with the present invention, the range of suction may be between −50 and −250 mm Hg.

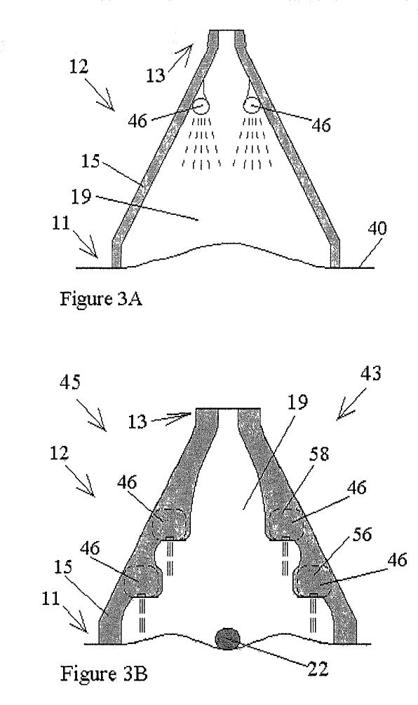

Referring further to the drawings, FIGS. 3A-3B schematically illustrate spout 12, comprising at least one light source 46, for providing light therapy, in accordance with preferred embodiments of the present invention. Light therapy may comprise a warming light therapy, for providing primarily a warming effect to the tissue, UV light therapy, for phototherapy of dermatoses, especially psoriasis, and Low Level Laser Therapy (LLLT). It will be appreciated that a combination of these may be employed, in tandem or in sequence. It will be further appreciated that other forms of light therapy are also possible.

As seen in FIG. 3A, warming light therapy may be provided with at least one light source 46 of one or several incandescent light bulbs, one or several halogen tubes, or one or several infrared light sources, arranged within inner chamber 19 of spout 12.

Alternatively, UV light therapy may be provided, for example by employing light source 46 as a low-pressure mercury vapor discharge lamp, as taught by U.S. Pat. No. 4,354,139, to Konijnendijk, et al., whose disclosure is incorporated herein by reference.

Alternatively, as seen in FIG. 3B, LLLLT may be provided by employing at least one light source 46 of one or several laser light sources, for example, laser diodes, preferably imbedded within casing 15

According to “Laser Therapy, http://www.skylarkdevice.com/english/laser_e.htm, 2000-2001 Skylark Inc., and according to LLLT, http://www.medsolution.de/LLLT.htm, both downloaded on Apr. 23, 2002, LLLT promotes the production of collagen and the synthesis of protein, accelerates blood circulation, increases lymphatic flow, excites cell division, improves immunity, revives white corpuscles, stimulates the synthesis of Adenosin Tri Phosphate (ATP), and increases the synthetic energy of nucleic acid. Additionally, LLLT can stimulate the skin to improve its tension and elasticity, reduce wrinkles, remove scars, and slow down skin aging.

As seen in FIG. 3B, the laser light diodes may be arranged in a single tier of diodes, or as two or more tiers of diodes, for example, tiers 56 and 58, wherein each tier of diodes may include between one and four diodes. It will be appreciated that other numbers are also possible. The plurality of Laser light diodes may emit substantially the same wavelength. Alternatively, two or more wavelengths may be used, as taught, for example, by U.S. Pat. No. 4,930,504 to Diamantopoulos, and by U.S. Pat. No. 5,755,751, to Eckhouse, whose disclosures are incorporated herein by reference. For example, tier 56 may operate at a first wavelength, tier 58 may operate at a second wavelength, and additional tiers may be employed, operating at other wavelengths.

The laser light diodes may be pulsed or continuous. When pulsed laser is used, pulsation may take place between a left side 45 and a right side 43, or between tiers of diodes such as tiers 56 and 58. Where more tiers are used, they may be pulsed in sequence. Additionally or alternatively, where two or more wavelengths are employed, they may be pulsed in sequence.

When using laser light source, eye pads (not shown), are worn, for protection. Alternatively, special protective glasses (not shown) may be provided with device 10.

Irradiation by the two or more wavelengths may be simultaneous. Alternatively, it may be sequential. Alternatively, the user may select a predetermined radiation schedule, which may be simultaneous, sequential, or restricted to only one or only two wavelengths, from amongst the wavelengths that are available.

The irradiation wavelength range may be 250-1500 nm. Specifically, the range 630-1200 nm may be used for biostimulation. The range 305-320 nm may be used for the treatment of psoriasis and other skin diseases. Additionally, as taught by U.S. Pat. No. 5,755,751, to Eckhouse, other wavelengths for example in the range 400-600, may be employed.

Laser light diodes 46 may be obtained, for example, from Photonic Devices, http://www.photonics.com. Alternatively, they may obtained from Coherent, www.coherent.com, which provide miniature laser diodes, of generally less than 10 mm in diameter and 2-3 mm in height.

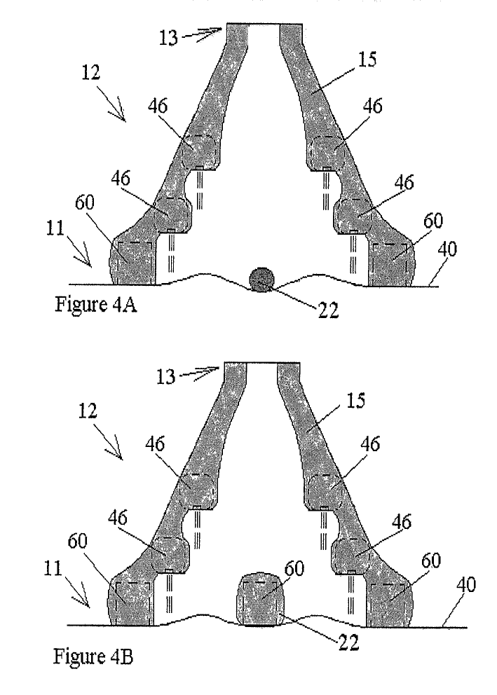

Referring further to the drawings, FIGS. 4A and 4B schematically illustrate spout 12, comprising an ultrasound transducer 60, in accordance with a preferred embodiment of the present invention, for providing ultrasound therapy.

According to “Ultrasound Therapy,” Skylark Inc., http://www.skylarkdevice.com/english/ultrasonic_e.htm#head, Ultrasound causes a is massaging or vibrating action, which may be regarded as a micro-massaging action. A consequence of it is a heating action. Massaging with 1 MHz for ten minutes may cause a temperature increase of 0.5-1° C., at a tissue depth of 4-5 cm. The warming effect increases blood circulation and tissue metabolism. Ultrasound also causes cavitation of the interface material, which leads to a cleansing of the skin. Additionally, ultrasound increases skin absorption of external matter.

Additionally, according to U.S. Pat. No. 6,325,769, whose disclosure is incorporated herein by reference, controlled application of ultrasound energy into the dermis layer reduces the extent of wrinkles and rejuvenate the skin. The ultrasound energy triggers a biological response that causes a synthesis of new connective tissue in the dermis through activation of fibroblast cells in the dermis without causing or requiring a significant irritation or a damage to the epidermis.

As seen in FIG. 4A, at least one, and preferably several ultrasound transducers 60 may be arranged within casing 15, so as to have direct contact with skin 40. Alternatively or additionally, one or several ultrasound transducers 60 may be arranged within roller 22, or bar 22, so as to have direct contact with skin 40. During use, a lubricant, such as a facial cream or a special gel may be used between surface 20 (FIG. 1A) and skin 40. Alternatively, collagen cream, or another beneficial cream may be used and absorbed by the skin as a result of the ultrasound action.

When using a continuous waveform, the frequency range may be about 1-5 MHz, at a recommended power of about 1 W/cm², for a treatment time of about 15 minutes, for general muscle treatment. The recommended power is about 0.5 W/cm², and the recommended treatment time is about 8-10 minutes, for facial treatment. Alternatively, when using a pulse waveform, the recommended power is about 240 mW/cm², for about 15 minutes, for general muscle treatment, and about 120 mW/cm²W/cm², for about 8-10 minutes, for facial treatment.

Ultrasound transducer 60, in the frequency range between 50 kHz and 2 MHz, at sizes as small as 0.2 in. external diameter and 0.36 in. in height, may be obtained, for example, from Digital Wave Corporation, 11234-A East Caley Av., Englewood, CO 80111 USA, Tel 303-790-7559, Fax. 303-790-7567, www.digitalwave.com.

As seen in FIGS. 4A and 4B, spout 12 may further include at least one light source 46, which may be any of the light sources described hereinabove, in conjunction with FIGS. 3A-3B. Preferably, the user may select either the a light therapy, such as LLLT therapy, or the ultrasound therapy, or both, in tandem or in sequence.

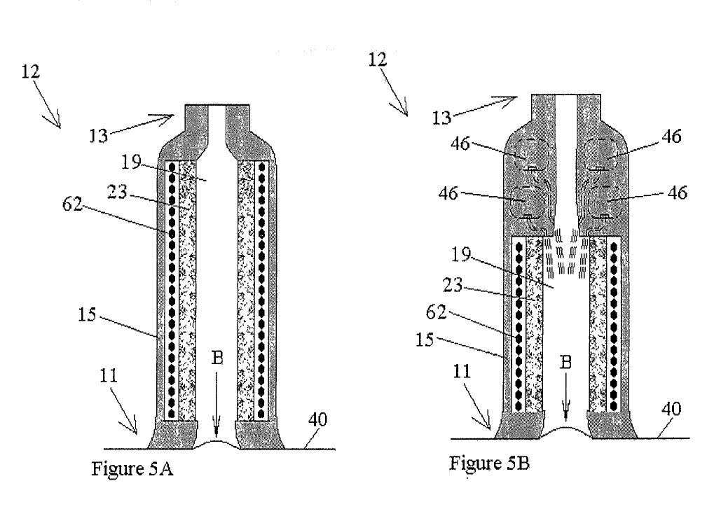

Referring further to the drawings, FIGS. 5A and 5B schematically illustrate spout 12, comprising an electromagnet 62, for providing pulsating magnetic field therapy, or constant magnetic field therapy, in accordance with preferred embodiments of the present invention.

According to “Magnetic and Electromagnetic Therapy,” By David Ramey, vwww.hcrc.organism/conntriib/ramey/magnet/html, Health Care Reality Check, downloaded on Nov. 20, 2001, some researchers believe that pulsating magnetic field may stimulate biological processes, pertinent for example, to osteogenesis, healing of chronic wounds, and neuroonal regeneration.

Preferably, electromagnet 62 comprises a conducting wire coil 62, arranged within casing 15. Additionally, an inner casing 23, preferably formed of a molded rigid plastic containing iron beads, iron filings, or the like, for example at a ratio of 1 part iron to 3 parts plastic, may be used on the side of conducting wire coil 62 facing inner chamber 19, to increase the magnetic field generated by conducting wire coil 62. When current flows in wire coil 62, a magnetic field B is formed. To generate a pulsating magnetic field, a pulsed DC voltage may be used. For example, a pulsed DC voltage having a rectangular wave form, pulsing at the rate of 10-60 cycles per minutes (CPM), the coil producing an average field of between 5 and 25 gauss, may be used. Alternatively, a constant DC voltage may be used, to form a constant magnetic field.

In accordance with the present invention, a permanent magnet may be used in place of wire coil 62, to form a constant magnetic field.

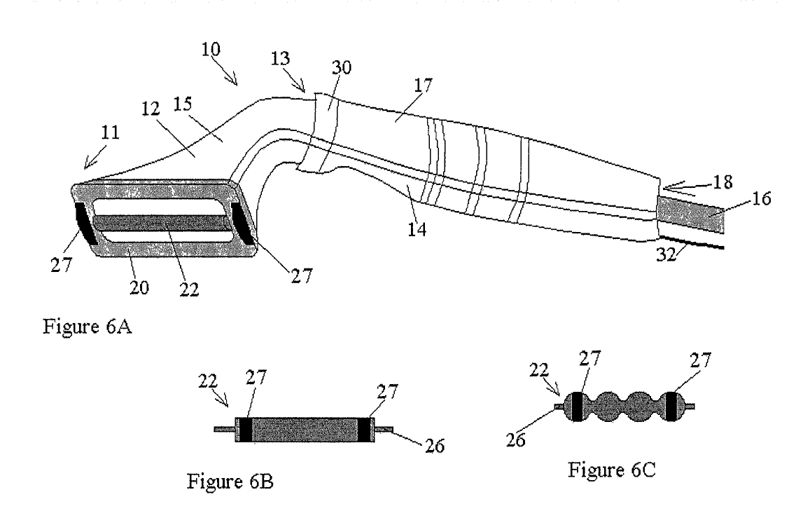

Referring further to the drawings, FIGS. 6A-6C schematically illustrate spout 12, comprising electrostimulating electrodes 27, for providing electrostimulation therapy, in accordance with a preferred embodiment of the present invention.

As seen in FIG. 6A electrostimulating electrodes 27 may be arranged on surface 20. Alternatively, as seen in FIGS. 6B and 6C, electrostimulating electrodes 27 may be arranged on roller 22. Electrodes 27 may be formed, for example, of stainless steel, titanium, or titanium alloy or another preferably noncorrosive, biocompatible conducting metal.

Preferably, electrostimulation therapy is performed at between 16 and 64 V, and up to 15 mA.

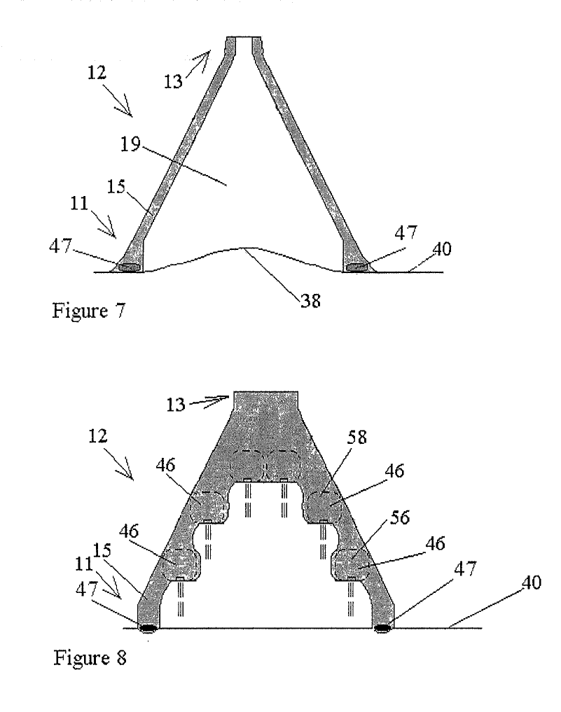

Referring further to the drawings, FIG. 7 schematically illustrates spout 12, comprising cooling diodes 47, arranged on surface 20, for providing cooling-diode therapy, in accordance with a preferred embodiment of the present invention. Cooling-diode therapy may be desired, for example, to close the skin pores, at a conclusion of a treatment. Alternatively, cycles of heating and cooling may be employed, by combining for example, warming-light therapy and cooling-diode therapy.

Additionally, in accordance with an embodiment of the present invention, cooling diodes 47 may be selectably flipped by the user, when desired, so as to operate as warming diodes, for providing a warming effect, or warming-diode therapy.

Preferably, diodes 47 operate at between 7-10° C. colder or warmer than the skin. However, other temperature values are also possible. Preferably, diodes 47 operate at 12 V and up to 7 amp.

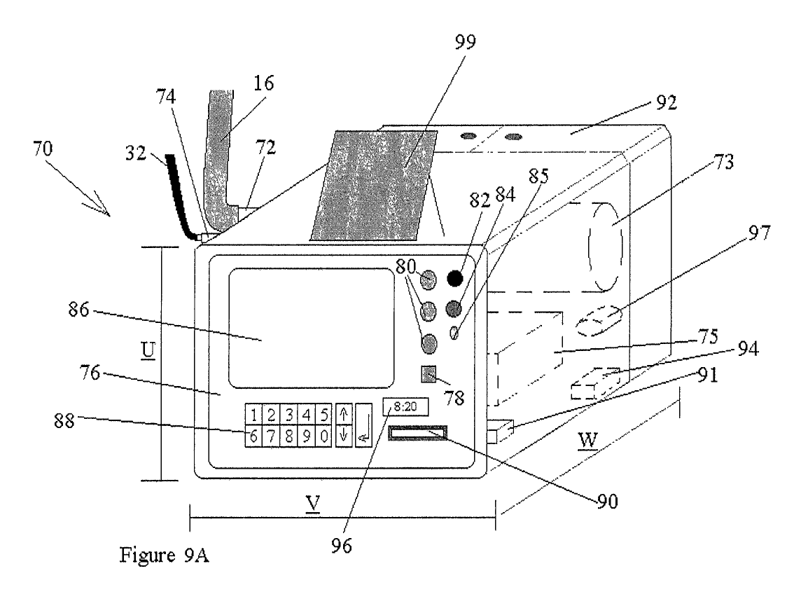

Referring further to the drawings, FIG. 8 schematically illustrates spout 12, comprising laser diodes 46, embedded within casing 15, and cooling diodes 47, arranged on surface 20, for providing LLLT, in combination with cooling-diode therapy, in accordance with a preferred embodiment of the present invention. It will be noted that spout 12 of FIG. 8 is not adapted for applying vacuum massage, but only other modes of therapy. Similarly, spout 12 may be adapted for light therapy with electrostimulation therapy, or ultrasound therapy with cooling diode therapy, or other combinations, in tandem or in sequence. Spout 12 may be further adapted for a combination of three or more modes of therapy, which may or may not include vacuum massage therapy.

Referring further to the drawings, FIGS. 9A and 9B schematically illustrate a power-and-control console 70 in accordance with preferred embodiments of the present invention. Preferably, power-and-control console 70 is elegantly and attractively designed and colored. A choice of colors may be provided.

Power-and-control console 70 provides vacuum to vacuum hose 16, via a vacuum line 72, in communication with a vacuum source 73, and power to cable 32, via a power line 74, preferably receiving power from a power supply unit 75. Additionally, power-and-control console 70 preferably includes a control panel 76, having an on/off knob or button 78 and preferably also several other knobs or buttons 80. Knobs 80 may he used to selectably activate different modes of therapy such as suction massage therapy, ultrasound therapy, pulsating magnetic field therapy, LLLT and others. Preferably, knobs 80 may also control the intensity and other variables of the treatment. For example, when ultrasound treatment is selected, knobs 80 may be used to select the desired frequency, the desired power range, and the desired duration of treatment. Similarly, when LLLT is selected, knobs 80 may be used to select the desired wavelength or wavelengths, the desired power range, and the desired duration of treatment. Additionally, knobs 80 may be used to select a treatment schedule, such as LLLT with suction massage, or LLLT directly after the suction massage, or another treatment schedule.

Knobs 78 and 80 may also be located directly on gripping handle 14. This allows the user to initially turn device 10 on from power-and-control console 70, but pause or change therapy modes directly from gripping handle 14.

Additionally, control panel 76 may also include a display panel 86, which may display the feature or schedule that was selected. Display panel 86 may be interactive, so the user may touch it to select features or schedules. Alternatively or additionally, a keyboard 88 may be provided, for selecting a desired feature or schedule.

Power-and-control console 70 may further include a controller 91 or a microcomputer 91, which may also include a memory. A read/write storage system 90 such as a diskette drive, a CD drive, or a mini CD drive may be used for storing or reading specific schedules.

Furthermore, power-and-control console 70 may include a clock 96, which is preferably digital, to clock the duration of a treatment.

Additionally, power-and-control console 70 may include a preferably rechargeable battery 94.

Preferably, control panel 76 also includes a light 82, for indicating that the system is on. Preferably a second light 84 may be provided as a warning light, for example, when the treatment time, or requested power level exceeds a recommended value. When this happens, controller 91 may stop the treatment.

Additionally, power-and-control console 70 may include a thermostat. A third light 85 may serve as a warning light, to indicate when power-and-control console 70 overheats. When this happens, controller 91 may stop the treatment.

Furthermore, power-and-control console 70 may include a short-circuit protection 97.

Preferably, a length V of power-and-control console 70 is 36 cm, a width W is 24 cm, and a height U is 13 cm. It will be appreciated that other dimensions are possible.

Power-and-control console 70 may further include a storage box 92 for storing accessories such as different spouts 12 and rollers 22, and a mirror 99, for allowing the user to view a facial treatment. Preferably, mirror 99 may be folded flat.

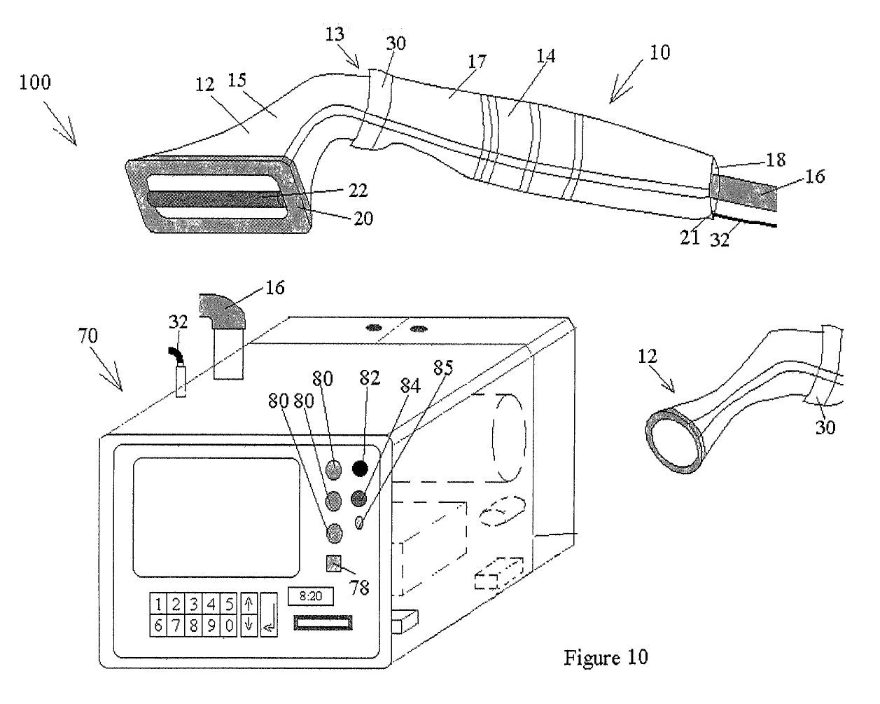

Referring further to the drawings, FIG. 10 schematically illustrates a system 100, comprising power-and-control console 70 and device 10, in accordance with a preferred embodiment of the present invention. Device 10 includes at least one, and preferably two or more spouts 12.

Preferably, power-and-control console 70 is lightweight and portable, making system 100 portable. When battery 94, which is preferably rechargeable, is used, system 100 may be used “on the go.” Preferably power-and-control console 70, device 10 and spouts 12 are arranged in an attractive carrying case, wherein power-and-control console 70 may be built into the carrying case.

In accordance with a preferred embodiment of the present invention, a plurality of spouts 12 may be provided, each having different features, adapted for a different 1o modes of therapy and (or) different portions of the body. The different modes of therapy may include:

1. suction massage therapy (FIG. 1C), which may comprise one or more rollers (FIGS. 1A-1G);

2. light therapy (FIGS. 3A and 3B), which includes:

i. warming light therapy;

ii. UV light therapy;

iii. LLLT;

3. ultrasound therapy (FIGS. 4A-4B);

4. magnetic field therapy (FIGS. 5A-5B) which includes:

i. pulsating magnetic field therapy; and

ii. constant magnetic field therapy;

5. electrostimulation therapy (FIGS. 6A-6C); and

6. cooling-diode therapy (FIG. 7); and

7. warming-diode therapy (FIG. 7).

In addition, spout 12 may combine several features, such as LLLT and ultrasound (FIGS. 4A and 4B), or LLLT and pulsating magnetic field therapy (FIG. 5B). Similarly, other combinations are possible. These may be applied in tandem, in sequence, in accordance with predetermined schedules, or at different times.

For example, spout 12 may be adapted for suction massage, and may further include laser diodes tiers 56 and 58 imbedded in casing 15 (FIG. 3B), cooling diodes 47 (FIG. 7), and ultrasound transducer 60, imbedded in roller 22 (FIG. 4B). A predetermined schedule, using spout 12, may comprise,

1. a first period of 10 min.: suction massage therapy with LLLT;

2. a second period of 5 min.: ultrasound therapy; and

3. a third period of 3 min.: cooling-diode therapy.

Alternatively, spout 12 may be adapted for suction massage, and may further include infrared light 46 (FIG. 3A), cooling diodes 47 (FIG. 7) and electrostimulating electrodes 27 (FIG. 6A-6C). A predetermined schedule, using spout 12, may comprise,

1. a first period of 8 min.: suction massage therapy with warming light is therapy.;

2. a second period of 8 min.: electrostimulation therapy; and

3. a third period of 3 min.: cooling-diode therapy.

It will be appreciated that many other predetermined schedules are similarly possible. Additionally, it will be appreciated that spout 12 may be used for the application of a single therapy, such as only suction massage therapy, only LLLT, or only ultrasound therapy.

Thus, in accordance with the present invention, self-application of a variety of face and body treatments is possible with device 10. The user may adhere to a predetermined schedule, or alternate between schedules, for example, a first predetermined schedule on Sundays and Tuesdays, a second predetermined schedule on Mondays and Wednesdays, and a third predetermined schedule on Fridays. Preferably, the schedules are based on clinical recommendations for the frequency and duration of different forms of therapy. Recommended predetermined schedules may be provided on diskettes, CD's, or the like, with system 100.

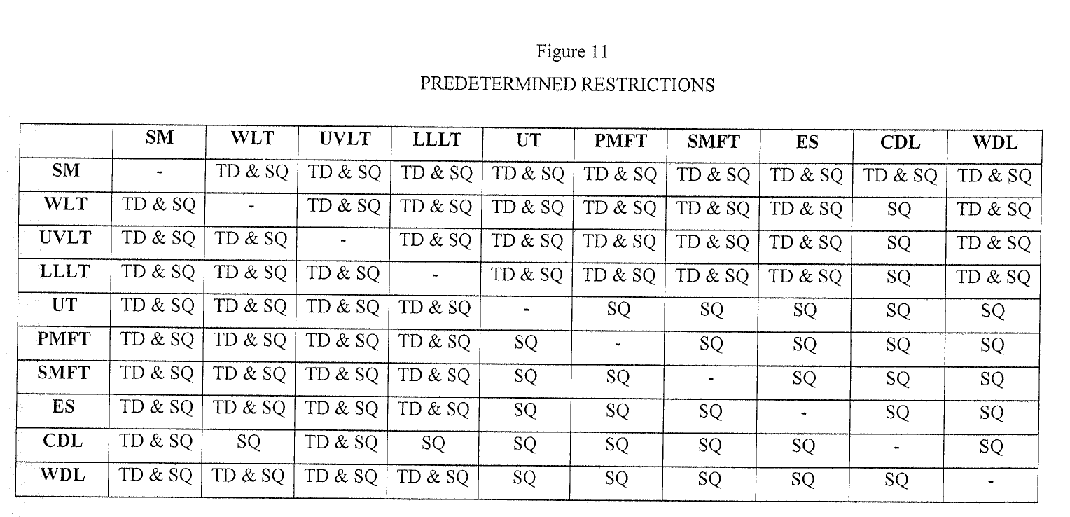

Referring further to the drawings, FIG. 11, which is arranged as a table, delineates certain predetermined restrictions regarding the different features and different modes of therapy of device 10, in accordance with the present invention. Certain modes of therapy, such as suction massage therapy and light therapy may be applied in tandem and in sequence. On the other hand, other modes may be applied only in sequence, as they interfere with each other. For example, electrostimulation is likely to interfere with the operation of a piezoelectric ultrasound transducer; thus tandem application of electrostimulation and ultrasound therapies is restricted. Similarly, cooling therapy will be ineffective, when conducted with warming light therapy, or with ultrasound therapy, both having warming effects on the tissue. In consequence, their tandem application is restricted. The key to the acronyms of FIG. 11 is as follows:

SM—suction massage therapy, with or without one or more rollers;

WLT—warming light therapy;

UVLT—UV light therapy;

LLLT—low level laser therapy;

UT—ultrasound therapy;

PMFT—pulsating magnetic field therapy;

SMFT—constant magnetic field therapy;

ES—electrostimulation therapy;

CDL—cooling-diode therapy;

WDL—warming-diode therapy;

TD & SQ—in tandem and in sequence; and

SQ—only in sequence.

In accordance with another preferred embodiment of the present invention, the user may buy system 100 with a limited number of spouts 12. Additionally, the user may upgrade his system 100 by buying additional spouts 12 at a later time.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A device for face and body treatment, comprising:
a spout, having a casing which defines an inner chamber, said spout being adapted for gliding along a portion of a body and applying suction massage therapy thereto;
a gripping handle, to which said spout is attached;
a vacuum hose, in fluid communication with said spout;
at least one light source, arranged within said inner chamber, adapted for applying light therapy, to the portion of the body; and
a power line, in power communication with said at least one light source.

2. The device of claim 1, wherein said gripping handle defines a lumen therein and comprises said vacuum hose.

3. The device of claim 1, wherein said power line is imbedded within said casing.

4. The device of claim 1, wherein said gripping handle comprises a connector, adapted to selectably receive and selectably detach said spout.

5. The device of claim 4, wherein said connector is adapted for swivel motion.

6. The device of claim 1, wherein said spout further includes at least one roller.

7. The device of claim 1, wherein said spout further includes at least two rollers.

8. The device of claim 1, wherein said spout is adapted to selectably apply each of said suction massage therapy and light therapy individually, and in tandem.

9. The device of claim 1, wherein said light therapy is selected from the group consisting of warming light therapy, UV light therapy, LLLT, and a combination thereof.

10. The device of claim 1, wherein said at least one light source comprises a plurality of light sources of a same type.

11. The device of claim 1, wherein said at least one light source comprises a plurality of light sources of different types.

12. The device of claim 1, wherein said at least one light source is adapted for heating the portion of the body.

13. The device of claim 1, wherein said at least one light source comprises a mercury vapor discharge lamp.

14. The device of claim 1, wherein said at least one light source comprises at least one laser light.

15. The device of claim 14, wherein said at least laser light comprises at least two laser lights of a same wavelength.

16. The device of claim 14, wherein said at least one laser light comprises at least two laser lights of different wavelengths.

17. The device of claim 14, wherein said at least one laser light is a pulsating laser light.

18. The device of claim 14, wherein said at least one laser light comprises at least one laser light diode.

19. The device of claim 1, wherein said at least one light source is operative at a wavelength range of 250-400 nm.

20. The device of claim 1, wherein said at least one light source is operative at a wavelength range of 300-320 nm.

21. The device of claim 1, wherein said at least one light source is operative at a wavelength range of 400-600 nm.

22. The device of claim 1, wherein said at least one light source is operative at a wavelength range of 600-700 nm.

23. The device of claim 1, wherein said at least one light source is operative at a wavelength range of 700-900 nm.

24. The device of claim 1, wherein said at least one light source is operative at a wavelength range of 900-1100 nm.

25. The device of claim 1, wherein said at least one light source is operative at a wavelength range of 1100-1500 nm.

26. The device of claim 1, wherein said spout further includes a first additional feature, for applying a first additional mode of therapy, selected from the group consisting of ultrasound therapy, pulsating magnetic field therapy, constant magnetic field therapy, electrostimulation therapy, cooling-diode therapy, and warming-diode therapy, wherein said therapies may be selectably applied in tandem and selectably applied in sequence, in accordance with predetermined restrictions.

27. The device of claim 26, wherein said therapies may be applied in accordance with a predetermined schedule.

28. The device of claim 26, wherein said spout further includes a second additional feature, for applying a second additional mode of therapy, different from said first additional mode, said second additional mode of therapy being selected from the group consisting of ultrasound therapy, pulsating magnetic field therapy, constant magnetic field therapy, electrostimulation therapy, cooling-diode therapy, and warming-diode therapy, wherein said therapies may be selectably applied in tandem and selectably applied in sequence, in accordance with predetermined restrictions.

29. The device of claim 28, wherein said therapies may be applied in accordance with a predetermined schedule.

30. The device of claim 1, wherein said device further includes at least one control knob.

31. The device of claim 1, wherein said device is adapted for self-application.

32. A device for face and body treatment, comprising:
a spout, having a casing which defines an inner chamber, said spout being adapted for gliding along a portion of a body and applying suction massage therapy thereto;
a gripping handle, to which said spout is attached;
a vacuum hose, in fluid communication with said spout;
an electromagnet, for applying a magnetic field therapy, to the portion of the body; and
a power line, in power communication with said electromagnet.

33. The device of claim 32, wherein said gripping handle defines a lumen therein and comprises said vacuum hose.

34. The device of claim 32, wherein said power line is imbedded within said casing.

35. The device of claim 32, wherein said gripping handle comprises a connector, adapted to selectably receive and selectably detach said spout.

36. The device of claim 35, wherein said connector is adapted for swivel motion.

37. The device of claim 32, wherein said spout further includes at least one roller.

38. The device of claim 32, wherein said spout further includes at least two rollers.

39. The device of claim 32, wherein said magnetic field therapy is selected from the group consisting of pulsating magnetic field therapy and constant magnetic field therapy.

40. The device of claim 32, wherein said spout is adapted to selectably apply each of said suction massage therapy and magnetic field therapy individually, and in tandem.

41. The device of claim 32, wherein said spout further includes a first additional feature, for applying a first additional mode of therapy, selected from the group consisting of warming light therapy, UV light therapy, LLLT, ultrasound therapy, electrostimulation therapy, cooling-diode therapy, and warming-diode therapy, wherein said therapies may be selectably applied in tandem and selectably applied in sequence, in accordance with predetermined restrictions.

42. The device of claim 41, wherein said therapies may be applied in accordance with a predetermined schedule.

43. The device of claim 41, wherein said spout further includes a second additional feature, for applying a second additional mode of therapy, different from said first additional mode, said second additional mode of therapy being selected from the group consisting of warming light therapy, UV light therapy, LLLT, ultrasound therapy, electrostimulation therapy, cooling-diode therapy, and warming-diode therapy, wherein said therapies may be selectably applied in tandem and selectably applied in sequence, in accordance with predetermined restrictions.

44. The device of claim 43, wherein said therapies may be applied in accordance with a predetermined schedule.

45. The device of claim 32, wherein said device further includes at least one control knob.

46. The device of claim 32, wherein said device is adapted for self-application.

47. A device for face and body treatment, comprising:
a spout, having a casing which defines an inner chamber, said spout being adapted for gliding along a portion of a body and applying suction massage therapy thereto;
a gripping handle, to which said spout is attached;
a vacuum hose, in fluid communication with said spout;
an electrode pair, for applying a electrostimulation therapy, to the portion of the body; and
a power line, in power communication with said electrode pair.

48. The device of claim 47, wherein said gripping handle defines a lumen therein and comprises said vacuum hose.

49. The device of claim 47, wherein said power line is imbedded within said casing.

50. The device of claim 47, wherein said gripping handle comprises a connector, adapted to selectably receive and selectably detach said spout.

51. The device of claim 50, wherein said connector is adapted for swivel motion.

52. The device of claim 47, wherein said spout further includes at least one roller.

53. The device of claim 47, wherein said spout further includes at least two rollers.

54. The device of claim 47, wherein said spout further includes a first additional feature, for applying a first additional mode of therapy, selected from the group consisting of warming light therapy, UV light therapy, LLLT, pulsating magnetic field therapy, constant magnetic field therapy, ultrasound therapy, cooling-diode therapy, and warming-diode therapy, wherein said therapies may be selectably applied in tandem and selectably applied in sequence, in accordance with predetermined restrictions.

55. The device of claim 54, wherein said therapies may be applied in accordance with a predetermined schedule.

56. The device of claim 54, wherein said spout further includes a second additional feature, for applying a second additional mode of therapy, different from said first additional mode, said second additional mode of therapy being selected from the group consisting of warming light therapy, UV light therapy, LLLT, pulsating magnetic field therapy, constant magnetic field therapy, ultrasound therapy, cooling-diode therapy, and warming-diode therapy, wherein said therapies may be selectably applied in tandem and selectably applied in sequence, in accordance with predetermined restrictions.

57. The device of claim 56, wherein said therapies may be applied in accordance with a predetermined schedule.

58. The device of claim 47, wherein said device further includes at least one control knob.

59. The device of claim 47, wherein said device is adapted for self-application.

60. A device for face and body treatment, comprising:
a spout, having a casing which defines an inner chamber, said spout being adapted for gliding along a portion of a body and applying suction massage therapy thereto;
a gripping handle, to which said spout is attached;
a vacuum hose, in fluid communication with said spout;
at least one cooling diode;
a power line, in power communication with said at least one cooling diode.

61. The device of claim 60, wherein said gripping handle defines a lumen therein and comprises said vacuum hose.

62. The device of claim 60, wherein said power line is imbedded within said casing.

63. The device of claim 60, wherein said gripping handle comprises a connector, adapted to selectably receive and selectably detach said spout.

64. The device of claim 63, wherein said connector is adapted for swivel motion.

65. The device of claim 60, wherein said spout further includes at least one roller.

66. The device of claim 60, wherein said spout is adapted to selectably apply cooling-diode therapy and said suction massage therapy individually, and in tandem.

67. The device of claim 60, wherein said at least one cooling diode further includes at least two cooling diodes.

68. The device of claim 60, wherein said at least one cooling diode may be flipped so as to operate as a warming diode, for providing warming-diode therapy.

69. The device of claim 60, wherein said device further includes at least one warming diode, wherein said cooling diode and said warming diode operate in cycles for cooling-warming therapy.

70. The device of claim 60, wherein said spout further includes a first additional feature, for applying a first additional mode of therapy, selected from the group consisting of warming light therapy, UV light therapy, LLLT, pulsating magnetic field therapy, constant magnetic field therapy, ultrasound therapy, and electrostimulation therapy, wherein said therapies may be selectably applied in tandem and selectably applied in sequence, in accordance with predetermined restrictions.

71. The device of claim 70, wherein said therapies may be applied in accordance with a predetermined schedule.

72. The device of claim 70, wherein said spout further includes a second additional feature, for applying a second additional mode of therapy, different from said first additional mode, said second additional mode of therapy being selected from the group consisting of warming light therapy, UV light therapy, LLLT, pulsating magnetic field therapy, constant magnetic field therapy, ultrasound therapy, and electrostimulation therapy, wherein said therapies may be selectably applied in tandem and selectably applied in sequence, in accordance with predetermined restrictions.

73. The device of claim 72, wherein said therapies may be applied in accordance with a predetermined schedule.

74. The device of claim 60, wherein said device further includes at least one control knob.

75. The device of claim 60, wherein said device is adapted for self-application.

76. A system for face and body treatment, comprising:
a device for face and body treatment, in accordance with claim 1; and
a power-and-control console, comprising:
an electric pump, in fluid communication with said device, for providing suction;
a power supply, in power communication with said device and said electric pump; and
at least one console control knob.

77. A system for face and body treatment, comprising:
a device for face and body treatment, comprising:
a spout, having a casing which defines an inner chamber, said spout being adapted for gliding along a portion of a body and applying thereto a basic mode of therapy in a form of suction massage therapy, and said spout comprising a feature, adapted for applying an added mode of therapy, selected from the group consisting of warming light therapy, UV light therapy, LLLT, pulsating magnetic field therapy, constant magnetic field therapy, electrostimulation therapy, cooling-diode therapy, and warming-diode therapy;
a gripping handle, to which said spout is attached;
a vacuum hose, in fluid communication with said spout; and
a power line, in power communication with said feature; and
a power-and-control console, comprising:
an electric pump, in fluid communication with said vacuum hose, for providing suction;
a power supply, in power communication with said power line and said electric pump; and
at least one console control knob.

78. The system of claim 77, wherein said gripping handle defines a lumen therein and comprises said vacuum hose.

79. The system of claim 77, wherein said power line is imbedded within said casing.

80. The system of claim 77, wherein said gripping handle comprises a connector, adapted to selectably receive and selectably detach said spout.

81. The system of claim 80, wherein said connector is adapted for swivel motion.

82. The system of claim 80, wherein said system includes at least one additional spout, designed to be received by said connector and adapted to apply a basic mode of therapy, selected from the group consisting of suction massage therapy, warming light therapy, UV light therapy, LLLT, pulsating magnetic field therapy, constant magnetic field therapy, ultrasound therapy, electrostimulation therapy, cooling-diode therapy, and warming-diode therapy.

83. The system of claim 80, wherein said system includes at least one additional spout, designed to be received by said connector and adapted to apply a basic mode of therapy and an added mode of therapy, different from said basic mode, both modes of therapy being selected from the group consisting of suction massage therapy, warming light therapy, UV light therapy, LLLT, pulsating magnetic field therapy, constant magnetic field therapy, electrostimulation therapy, cooling-diode therapy, and warming-diode therapy.

84. The system of claim 77, wherein said spout further includes at least one roller.

85. The system of claim 77, wherein said spout further includes at least two rollers.

86. The system of claim 77, wherein said spout is adapted to selectably apply each of said suction massage therapy and said added mode of therapy individually, and in tandem.

87. The system of claim 77, wherein said spout is adapted to apply each of said suction massage therapy and said added mode of therapy in accordance with a predetermined schedule.

88. The system of claim 77, wherein said spout further includes a first additional feature, for applying a first additional mode of therapy, selected from the group consisting of warming light therapy, UV light therapy, LLLT, pulsating magnetic field therapy, constant magnetic field therapy, ultrasound therapy, electrostimulation therapy, cooling-diode therapy, and warming-diode therapy, wherein said therapies may be selectably applied in tandem and selectably applied in sequence, in accordance with predetermined restrictions.

89. The system of claim 88, wherein said therapies may be applied in accordance with a predetermined schedule.

90. The system of claim 88, wherein said spout further includes a second additional feature, for applying a second additional mode of therapy, different from said first additional mode, said second additional mode of therapy being selected from the group consisting of warming light therapy, UV light therapy, LLLT, pulsating magnetic field therapy, constant magnetic field therapy, ultrasound therapy, electrostimulation therapy, cooling-diode therapy, and warming-diode therapy, wherein said therapies may be selectably applied in tandem and selectably applied in sequence, in accordance with predetermined restrictions.

91. The system of claim 90, wherein said therapies may be applied in accordance with a predetermined schedule.

92. The system of claim 77, wherein said device further includes at least one device control knob.

93. The system of claim 77, wherein said system is portable.

94. The system of claim 77, wherein said power supply includes a battery.

95. The system of claim 77, wherein said system includes a controller.

96. The system of claim 77, wherein said system includes a display panel.

97. The system of claim 96, wherein said display panel is interactive.

98. The system of claim 77, wherein said device is adapted for self-application.

99. A method for face and body treatment, comprising:
employing a single device;
applying a basic mode of therapy, selected from the group consisting of suction massage therapy, warming light therapy, UV light therapy, LLLT, pulsating magnetic field therapy, constant magnetic field therapy, electrostimulation therapy, cooling-diode therapy, and warming-diode therapy; and
applying an added mode of therapy, different from said basic mode, said added mode of therapy being selected from the group consisting of suction massage therapy, warming light therapy, UV light therapy, LLLT, pulsating magnetic field therapy, constant magnetic field therapy, electrostimulation therapy, cooling-diode therapy, and warming-diode therapy,
wherein said basic and added modes of therapy may be selectably applied in tandem, and selectably applied in sequence, in accordance with predetermined restrictions.

100. The method of claim 99, wherein said basic and added modes of therapy are applied in accordance with a predetermined schedule.

101. The method of claim 99, wherein said basic and added modes of therapy are self-applied.

102. The method of claim 99 and further including applying a first additional mode of therapy, different from said basic and added modes, said first additional mode of therapy being selected from the group consisting of suction massage therapy, warming light therapy, UV light therapy, LLLT, ultrasound therapy, pulsating magnetic field therapy, constant magnetic field therapy, electrostimulation therapy, cooling-diode therapy, and warming-diode therapy,
wherein said therapies may be selectably applied in tandem, and selectably applied in sequence, in accordance with predetermined restrictions.

103. The method of claim 102, wherein said therapies are applied in accordance with a predetermined schedule.

104. The method of claim 102, wherein said therapies are self-applied.

105. The method of claim 102 and further including applying a second additional mode of therapy, different from said first additional mode and said basic and added modes, said second additional mode of therapy being selected from the group consisting of suction massage therapy, warming light therapy, UV light therapy, LLLT, ultrasound therapy, pulsating magnetic field therapy, constant magnetic field therapy, electrostimulation therapy, cooling-diode therapy, and warming-diode therapy,
wherein therapies may be selectably applied in tandem, and selectably applied in sequence, in accordance with predetermined restrictions.

106. The method of claim 105, wherein said therapies are applied in accordance with a predetermined schedule.

107. The method of claim 105, wherein said therapies are self-applied.

108. A system for face and body treatment, comprising:
a device for face and body treatment, comprising:
a spout, comprising a first feature, adapted for applying a basic mode of therapy, and a second feature, adapted for applying an added mode of therapy, different from said first mode, both modes of therapy being selected from the group consisting of warming light therapy, UV light therapy, LLLT, ultrasound therapy, pulsating magnetic field therapy, constant magnetic field therapy, electrostimulation therapy, cooling-diode therapy, and warming-diode therapy;
a gripping handle, to which said spout is attached; and
a power line, in power communication with said first and second features; and
a power-and-control console, comprising:
a power supply, in power communication with said device; and
at least one console control knob.

109. The system of claim 108, wherein said power line is imbedded within said gripping handle.

110. The system of claim 108, wherein said gripping handle comprises a connector, adapted to selectably receive and selectably detach said spout.

111. The system of claim 110, wherein said connector is adapted for swivel motion.

112. The system of claim 110, wherein said system includes at least one additional spout, designed to be received by said connector and adapted to apply a basic mode of therapy, selected from the group consisting of warming light therapy, UV light therapy, LLLT, pulsating magnetic field therapy, constant magnetic field therapy, ultrasound therapy, electrostimulation therapy, cooling-diode therapy, and warming-diode therapy.

113. The system of claim 110, wherein said system includes at least one additional spout, designed to be received by said connector and adapted to apply a basic mode of therapy and an added mode of therapy, different from said basic mode, both modes of therapy being selected from the group consisting of warming light therapy, UV light therapy, LLLT, ultrasound therapy, pulsating magnetic field therapy, constant magnetic field therapy, electrostimulation therapy, cooling-diode therapy, and warming-diode therapy.

114. The system of claim 108, wherein said spout further includes a first additional feature, for applying a first additional mode of therapy, selected from the group consisting of warming light therapy, UV light therapy, LLLT, pulsating magnetic field therapy, constant magnetic field therapy, ultrasound therapy, electrostimulation therapy, cooling-diode therapy, and warming-diode therapy, wherein said therapies may be selectably applied in tandem and selectably applied in sequence, in accordance with predetermined restrictions.

115. The system of claim 114, wherein said therapies may be applied in accordance with a predetermined schedule.

116. The system of claim 114, wherein said spout further includes a second additional feature, for applying a second additional mode of therapy, different from said first additional mode, said second additional mode of therapy being selected from the group consisting of warming light therapy, UV light therapy, LLLT, pulsating magnetic field therapy, constant magnetic field therapy, ultrasound therapy, electrostimulation therapy, cooling-diode therapy, and warming-diode therapy, wherein said therapies may be selectably applied in tandem and selectably applied in sequence, in accordance with predetermined restrictions.

117. The system of claim 116, wherein said therapies may be applied in accordance with a predetermined schedule.

118. The system of claim 108, wherein said device further includes at least one device control knob.

119. The system of claim 108, wherein said system is portable.

120. The system of claim 108, wherein said power supply includes a battery.

121. The system of claim 120, wherein said battery is rechargeable.

122. The system of claim 108, wherein said system includes a controller.

123. The system of claim 108, wherein said system includes a display panel.

124. The system of claim 123, wherein said display panel is interactive.

125. The system of claim 108, wherein said therapies may be selectably applied in tandem and selectably applied in sequence, in accordance with predetermined restrictions.

126. The system of claim 108, wherein said therapies may be applied in accordance with a predetermined schedule.

127. The system of claim 108, wherein said device is adapted for self-application.
